(19) United States
(12) Patent Application Publication
(10) Pub. No.: US 2016/0004968 A1
(43) Pub. Date: Jan. 7, 2016

(54) CORRELATION RULE ANALYSIS APPARATUS AND CORRELATION RULE ANALYSIS METHOD

(71) Applicant: HITACHI, LTD., Tokyo (JP)

(72) Inventors: Yasunori HASHIMOTO, Tokyo (JP); Keishi OOSHIMA, Tokyo (JP); Hirofumi DANNO, Tokyo (JP); Ryota MIBE, Tokyo (JP); Kiyoshi YAMAGUCHI, Tokyo (JP)

(73) Assignee: HITACHI, LTD., Tokyo (JP)

(21) Appl. No.: 14/614,006

(22) Filed: Feb. 4, 2015

(30) Foreign Application Priority Data
Jul. 1, 2014 (JP) 2014-135511

(51) Int. Cl. G06N 5/02

(52) U.S. Cl. CPC G06N 5/025

(57) ABSTRACT

A correlation rule analysis apparatus extracts data dependence relation and restriction conditions of database columns of a database from data stored in the database. The correction rule analysis apparatus includes a correlation rule extraction part which extracts information of simultaneous appearance relation of data among plural columns as correlation rules from inputted database table data, a correlation rule summarization part which summarizes or puts the extracted correlation rules together on the basis of specific community and a summarization result appropriateness judgment part which calculates usefulness indexes as the data dependence relation and the restriction conditions from appearance frequency and combination in the summarized correlation rules.

### INCORPORATION BY REFERENCE

The present application claims priority from Japanese application JP2014-135511 filed on Jul. 1, 2014, the content of which is hereby incorporated by reference into this application.

### BACKGROUND OF THE INVENTION

The present invention relates to the technique of analyzing the correlation rules for grasping the specifications of a database (DB) utilized in an information system of an object for the purpose of development and the like of the information system.

As a background art of the technical field, JP-A-H11-259567 (patent literature 1) may be referred to. This publication discloses that “the technique capable of extracting a data set of competing events and searching for the data set having the strong relationship even if a rate of occurrence is low is provided” for the purpose of the analysis of the correlation rules (refer to the abstract).

### SUMMARY OF THE INVENTION

### Technical Problem

In development and maintenance of the information system, it is important to understand the specifications of the database (DB). The specifications of the database are sometimes described in the specification document explicitly but are sometimes prescribed tacitly. In order to understand the tacit specifications, the technique of extracting the features from data in the database is effective. Concretely, the basket analysis can be used to find out the dependence relation and restriction conditions (one side of the specifications) to be satisfied by the data preserved in the database from the rules (correlation rules) of the simultaneous appearance relation of the data. Further, in the present invention, a relational database (RDB) is supposed as the database specifically. At this time, the data dependence relation and restriction conditions existing among columns can be found out by means of the basket analysis.

For example, in a table of a certain relational database, if the correlation rule that “a value of “deletion date” is not necessarily NULL when the value of a “deletion flag” is “1”” can be found out by the basket analysis”, the existence of the specifications that “the value of the “deletion date” is indispensable when the “deletion flag” is “1”” can be presumed.

Generally, in the basket analysis, a large number of correlation rules are produced in many cases. Accordingly, it is necessary to figure out a way to reduce time and effort at the time that a human being makes confirmation. Further, measures for (1) reducing the total number of the correlation rules by summarizing or putting the extracted correlation rules together and (2) scoring the correlation rules mechanically so as to make it possible to adapt the correlation rules for filtering and ranking (sorting) are used.

In the scoring (2) of them, support, confidence and lift values which are index values of the correlation rules are used in many cases. Moreover, the patent literature 1 describes the method of reflecting the “rule which has a low evaluation in the conventional basket analysis but is useful” to the score by means of indexes such as “expectation relation index” and “relation strength index”.

However, numerical expression of the rules in the above conventional methods is made to only usefulness as individual correlation rules and the indexes indicating the usefulness as the specifications existing among columns are not considered. The specifications existing among columns include plural correlation rules and accordingly there is a problem that analysis using only such indexes is insufficient.

The index values expressed numerically by the conventional methods treat all correlation rules uniformly and do not consider the characteristics as the specifications.

Concretely, evaluation values for the correlation rule indicating the correspondence relation of data (for example, when “annual paid holiday flag” is “1”, “substitute day off flag” is “0”) and the correlation rule indicating the magnitude relation of data (for example, when “selling price” is “105”, “material cost” is “30”) are calculated by the same method. Hence, there is a problem that the evaluation values indicating the usefulness of the correlation rules properly cannot be calculated (concretely, description is made in embodiments).

Accordingly, it is an object of the present invention to provide an apparatus for numerically expressing the usefulness as the specifications existing among columns of a relational database table by integrating plural correlation rules and producing evaluation values in the viewpoint of considering the characteristics of data to thereby make scoring of the correlation rules properly from the viewpoint as the specifications of the relational database.

### Solution to Problem

In order to solve the above problems, according to the present invention, the ratio between the appearance rate of conditions for data and the rate that the restriction is satisfied is used as the above scoring. This result can be used for summarizing or putting the correlation rules together. In more detail, the following structure is adopted. The correlation rule analysis apparatus which extracts at least any of data dependence relation and restriction conditions of columns of a database from data stored in the database, comprises correlation rule extraction means to extract information of simultaneous appearance relation of data among plural columns as correlation rules from data of a database table in which data to be analyzed are stored, correlation rule summarization means to summarize the extracted correlation rules on the basis of specific community and summarization result appropriateness judgment means to calculate usefulness indexes including at least one of the data dependence relation and the restriction conditions from appearance frequency and combination in the summarized correlation rules. Here, in the present specification, the “simultaneous appearance relation” means that when one appears, the other also appears and appearances are not necessarily required to be coincident temporally. Further, the present invention includes a computer program for realizing a method and the apparatus.

### Advantageous Effects of Invention

According to the present invention, the correlation rules extracted from data of a relational database can be scored from the viewpoint as the specifications of the relational database. Thus, for example, when the user of the present invention analyzes the specifications of the relational database, additional information for confirming the correlation rules which is information indicating the specifications while ranking and filtering the correlation rules properly can be provided. Accordingly, the analysis work of the specifications of the relational database can be made more efficient.

It should be further understood by those skilled in the art that although the foregoing description has been made on embodiments of the invention, the invention is not limited thereto and various changes and modifications may be made without departing from the spirit of the invention and the scope of the appended claims.

### BRIEF DESCRIPTION OF THE DRAWINGS

FIG. 1 shows an example of a diagram schematically illustrating a correlation rule analysis apparatus according to an embodiment of the present invention;

FIG. 2 shows an example of a flow chart explaining the processing of the correlation rule analysis apparatus in the embodiment of the present invention;

FIG. 3 shows an example of an image diagram explaining data of a table read from a database in the embodiment of the present invention;

FIG. 4 shows an example of an image diagram explaining the processing for counting appearances of column values in the embodiment of the present invention;

FIG. 5 shows an example of an image diagram explaining column characteristic judgment rules in the embodiment of the present invention;

FIG. 6 shows an example of an image diagram explaining the processing for preparing column characteristic information in the embodiment of the present invention;

FIG. 7 shows an example of an image diagram explaining the processing for counting appearances of sets of column values in the embodiment of the present invention;

FIG. 8 shows an example of an image diagram explaining correlation rule summarization rules in the embodiment of the present invention;

FIG. 9 shows an example of an image diagram explaining the processing for selecting correlation rule summarization rules in the embodiment of the present invention;

FIG. 10 shows an example of an image diagram explaining the processing for deriving correlation rule summarization names in the embodiment of the present invention;

FIG. 11 shows an example of an image diagram explaining the processing for rearranging correlation rules in the embodiment of the present invention;

FIG. 12 shows an example of an image diagram explaining the processing for complementing information of the number of items on the cause side of correlation rules rearranged in the embodiment of the present invention;

FIG. 13 shows an example of an image diagram explaining the processing for complementing information of the number of items on the result side of correlation rules rearranged in the embodiment of the present invention;

FIG. 14 shows an example of an image diagram explaining the number of times of appearances of column values used to efficiently perform the processing for complementing information for correlation rules in the embodiment of the present invention;

FIG. 15 shows an example of an image diagram explaining the processing for calculating index values from information of correlation rules to be updated in the embodiment of the present invention;

FIG. 16 shows an example of an image diagram explaining the processing for summarizing or putting correlation rules together in the embodiment of the present invention;

FIG. 17 shows an example of an image diagram explaining difference depending on Lift for correlation rule summarization results in the embodiment of the present invention;

FIG. 18 shows an example of an image diagram explaining rules for complementing information of correlation rule summarization results in the embodiment of the present invention;

FIG. 19 shows an example of an image diagram explaining the processing for complementing information of correlation rule summarization results in the embodiment of the present invention; and

FIG. 20 shows an example of an image diagram explaining the processing for converting correlation rule summarization results into a visually and easily understandable format in the embodiment of the present invention.

### DESCRIPTION OF THE EMBODIMENTS

An embodiment of the present invention is now described referring to the accompanying drawings.

In the embodiment, an example of a correlation rule analysis apparatus is described.

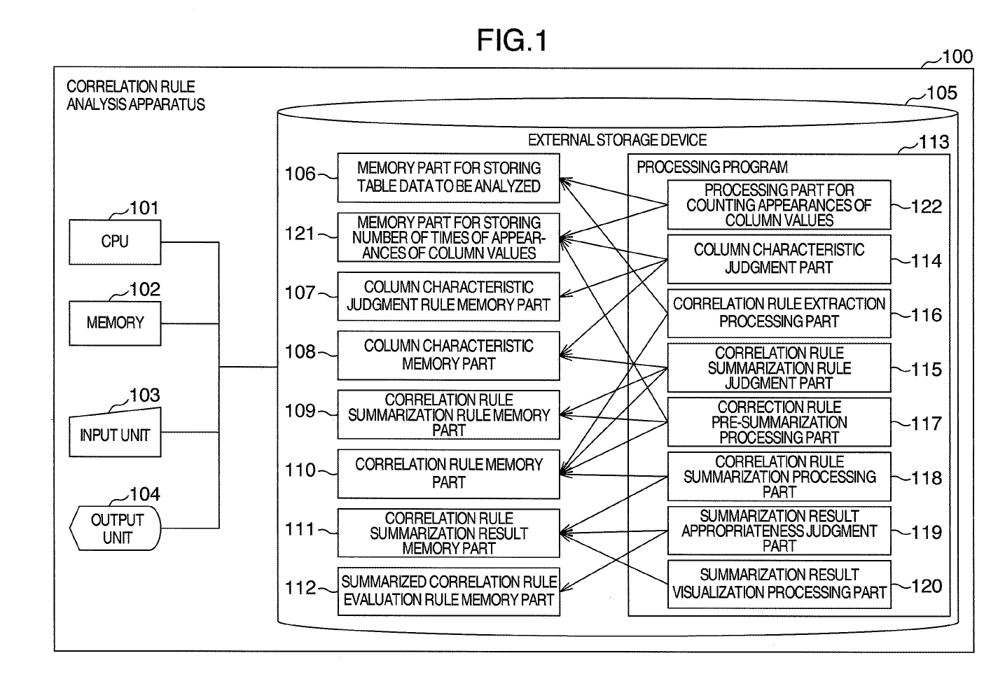

FIG. 1 is an example of a diagram schematically illustrating a correlation rule analysis apparatus of the embodiment. The correlation rule analysis apparatus 100 includes a CPU 101, a memory 102, an input unit 103, an output unit 104 and an external storage device 105. That is, the correlation rule analysis apparatus is realized by a so-called computer. The external storage device 105 includes a memory part 106 for storing table data to be analyzed, a memory part 121 for storing the number of times of appearances of column values, a column characteristic judgment rule memory part 107, a column characteristic memory part 108, a correlation rule summarization rule memory part 109, a correlation rule memory part 110, a correlation rule summarization result memory part 111, a summarized correlation rule evaluation rule memory part 112 and a processing program 113. The processing program 113 includes a processing part 122 for counting appearances of column values, a column characteristic judgment part 114, a correction rule summarization rule judgment part 115, a correlation rule extraction processing part 116, a correction rule pre-summarization processing part 117, a correlation rule summarization processing part 118, a summarization result appropriateness judgment part 119 and a summarization result visualization processing part 120.

It is supposed that the processing program 113 is read in the memory 102 at the time of execution and is executed by the CPU 101. The processing contents thereof are described later with reference to the flow charts.

The column characteristic judgment rule memory part 107, the correlation rule summarization rule memory part 109 and the summarized correlation rule evaluation rule memory part 112 are previously provided with column characteristic judgment rules, correlation rule summarization rules and summarized correlation rule evaluation rules, respectively, and details of the column characteristic judgment rules, correlation rule summarization rules and summarized correlation rule evaluation rules are described later.

Data of a relational database table inputted externally by means of the input unit 103 are written in the memory part 106 for storing table data to be analyzed.

The processing part 122 for counting appearances of column values counts appearances of data in respective columns while referring to data of columns read out from the memory part 106 for storing table data to be analyzed and writes the results thereof into the memory part 121 for storing the number of times of appearances of column values.

The column characteristic judgment part 114 prepares column characteristic information using the column characteristic judgment rules read out from the column characteristic judgment rule memory part 107 while referring to the number of times of appearances of column values read out from the memory part 121 for storing the number of times of appearances of column values and writes the column characteristic information into the column characteristic memory part 108.

The correlation rule extraction processing part 116 counts appearances of sets of values in columns while referring to data of columns read out from the memory part 106 for storing table data to be analyzed and writes the result thereof into the correlation rule memory part 110.

The correlation rule summarization rule judgment part 115 selects correlation rule summarization rules using correlation rule summarization rules read out from the correlation rule summarization rule memory part 109 while referring to the column characteristic information read out from the column characteristic memory part 108 and writes the selected correlation rule summarization rules as information of the correlation rules stored in the correlation rule memory part 110. Further, the correlation rule summarization rule judgment part 115 derives correlation rule summarization names for extracted correlation rules using the selected correlation rule summarization rules and writes the derived correlation rule summarization names as information of the correlation rules stored in the correlation rule memory part 110.

The correlation rule pre-summarization processing part 117 rearranges the correlation rules read out from the correlation rule memory part 110 and updates information in the correlation rule memory part 110. Further, the correlation rule pre-summarization processing part 117 reads out the correlation rules from the correlation rule memory part 110 and calculates necessary numerical values while referring to the number of times of appearances of column values read out from the memory part 121 for storing the number of times of appearances of column values and the correlation rule summarization rules read out from the correlation rule summarization rule memory part 109 to thereby complement the information. Thereafter, the correlation rule pre-summarization processing part 117 writes the numerical values as the correlation rules in the correlation rule memory part 110 again. Moreover, the correlation rule pre-summarization processing part 117 calculates index values of the correlation rules using the information of the correlation rules read out from the correlation rule memory part 110 and updates the information of the correction rules. Thereafter, the correlation rule pre-summarization processing part 117 writes the information as the correlation rule of the correlation rule memory part 110 again.

The correlation rule summarization processing part 118 summarizes or puts the information of the correlation rules read out from the correlation rule memory part 110 together on the basis of the community of summarization names of the correlation rules and thereafter writes the information in the correlation rule summarization result memory part 111 as the summarized correlation rules.

The summarization result appropriateness judgment part 119 refers to the information of the summarized correlation rules read out from the correlation rule summarization result memory part 111 to be complemented using the information of the summarized correlation rule evaluation rules read out from the summarized correlation rule evaluation rule memory part 112 and thereafter writes the correlation rule into the summarized correlation rule memory part 111 again.

The summarization result visualization processing part 120 reads out the correlation rule summarization result from the correlation rule summarization result memory part 111 in accordance with the user's instruction of the apparatus and converts it into a visually and easily understandable format. Thereafter, the summarization result visualization processing part 120 outputs it onto the output unit 104.

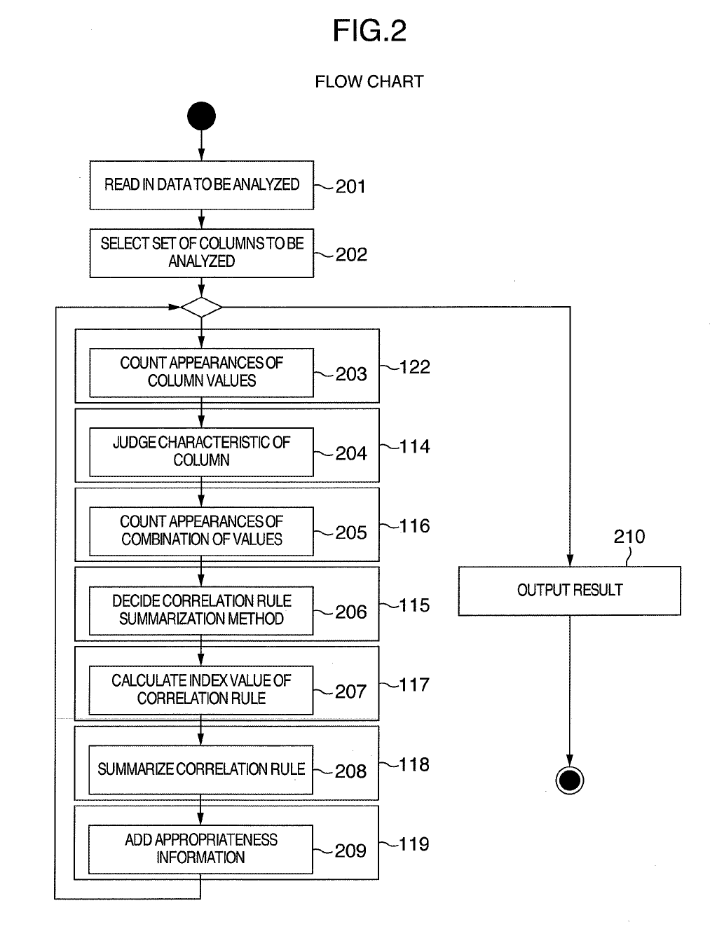

FIG. 2 shows an example of a flow chart explaining the processing of the correlation rule analysis apparatus in the embodiment. Operation of each part of FIG. 1 is now described with reference to the flow chart of FIG. 2.

In step 201, data of the relational database table is inputted as input information to the correlation rule analysis apparatus. The input operation is made by the user of the apparatus. In step 201, data corresponding to one table from among data of the relational database inputted from the input unit 103 are written into the memory part 106 for storing table data to be analyzed.

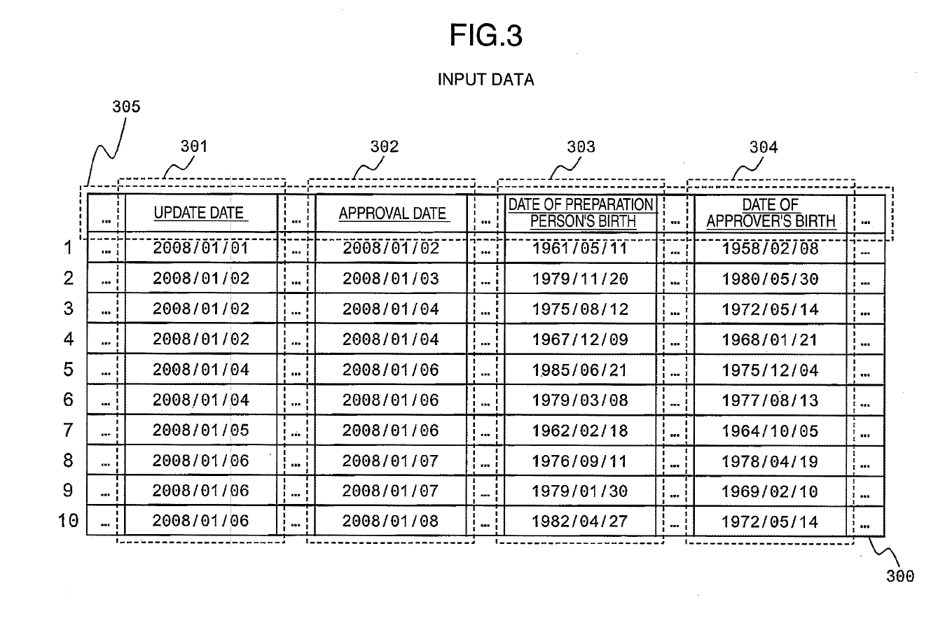

FIG. 3 shows an example of an image diagram explaining the table data read in from the database in the embodiment. Input data 300 has records of 10 lines in total and each record has 4 columns including “update date” 301, “approval date” 302, “date of preparation person's birth” 303 and “date of approver's birth” 304. Furthermore, it is supposed that identifiers for specifying respective columns are given to a header line 305. In addition, information corresponding to the header line 305 is not indispensable as the input information. When the information is not given as the input information to the analysis apparatus, an ID unique to each column is mechanically given in the analysis apparatus 100 and the ID may be used as alternative information for the header line 305, so that the following steps may be advanced.

In step 202, a set of columns to be analyzed is selected as the input information to the correlation rule analysis apparatus. The selection operation is made by the user of the apparatus.

The information for the column set includes a set of “cause-side column” and “result-side column”. The “cause-side column” and the “result-side column” will be described in step 205 and subsequent steps thereto in the embodiment. In the embodiment, unless otherwise described below, the case where the user of the apparatus selects the “update date” 301 as the “cause-side column” and the “approval date” 302 as the result-side column name is supposed to make description. Moreover, this step may be omitted and combination of columns may be analyzed.

The processing in the following steps 203 to 209 is the mechanical processing based on the input information and can be performed only by the database analysis apparatus without hand.

In step 203, the processing part 122 for counting appearances of column values counts appearances of column data while referring to the column data read out from the memory part 106 for storing table data to be analyzed and writes the counted result in the memory part 121 for storing the number of times of appearances of column values.

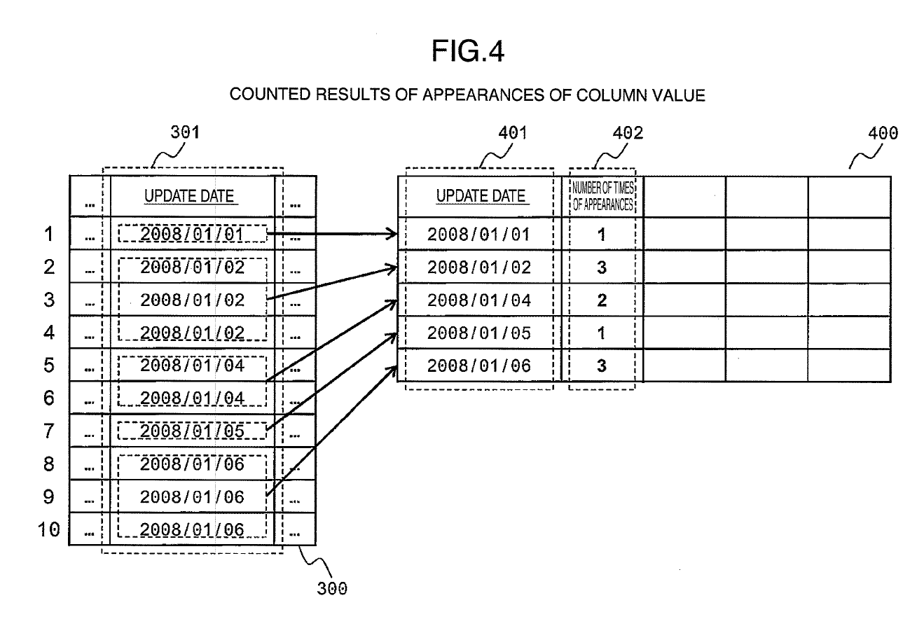

FIG. 4 shows an example of an image diagram explaining the processing for counting appearances of column values in the embodiment. The processing part 122 for counting appearances of column values prepares information indicating the number of times of appearances of column values for respective columns contained in the column set selected in step 202 of the columns held in the input data 300. The information 400 indicating the number of times of appearances of column values in FIG. 4 corresponds to the “update date” column 301 described in FIG. 3. The information 400 indicating the number of times of appearances of column values includes column values 401 and the number of times of appearances 402. The column value characteristic information judgment part 106 eliminates duplicate values of the “update date” column 301 and preserves the values as information of the column values 401. Further, the column value characteristic information judgment part 106 counts appearances of values of the column values 401 in the “update date” column by referring to the “update date” column 301 and registers the counted result as information indicating the number of times of appearances.

The processing about the “update date” 301 has been described with reference to FIG. 4, although the same processing is performed even about the “approval date” 302 contained in the set of columns selected in step 202. In step 204, the column characteristic judgment part 114 prepares the column characteristic information by the use of the column characteristic judgment rules read out from the column characteristic judgment rule memory part 107 while referring to the number of times of appearances of the column values read out from the memory part 121 for storing the number of times of appearances of column values and writes the column characteristic information in the column characteristic memory part 108.

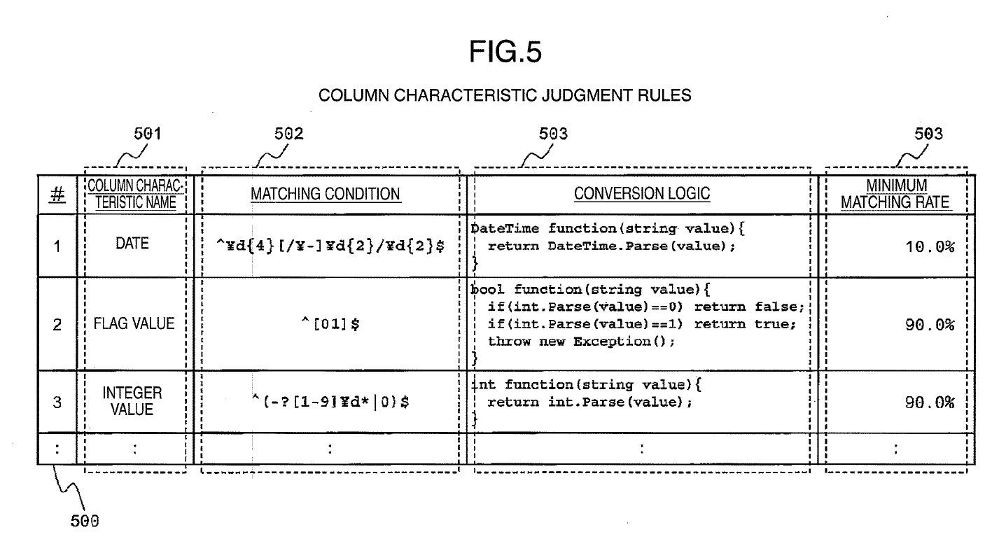

FIG. 5 shows an example of an image diagram explaining the column characteristic judgment rules in the embodiment. The column characteristic judgment rules 500 have column characteristic names 501 and matching conditions 502. The column characteristic names 501 are given unique ID's for specifying the column characteristics. The matching conditions 502 show conditions for judging that a certain value has the column characteristic and are shown in normal expression in FIG. 5. This means that a certain column is judged to be the column characteristic when the column is a character string matching with the normal expression in the appearance value of the column at a fixed or more rate. In the embodiment, the “fixed rate” is a threshold which does not depend on the column characteristic and is supposed to be 80%. Further, the threshold may be a value different for each column characteristic.

Moreover, as in the embodiment, when the values of columns are given by the character strings, conversion logics 503 may be provided as functions for converting the values into quantitative values. In the following description of the embodiment, it is supposed that evaluation and processing are made after the column values are converted by such conversion logics in case where the column values are treated in partial order relation specifically even unless noted otherwise.

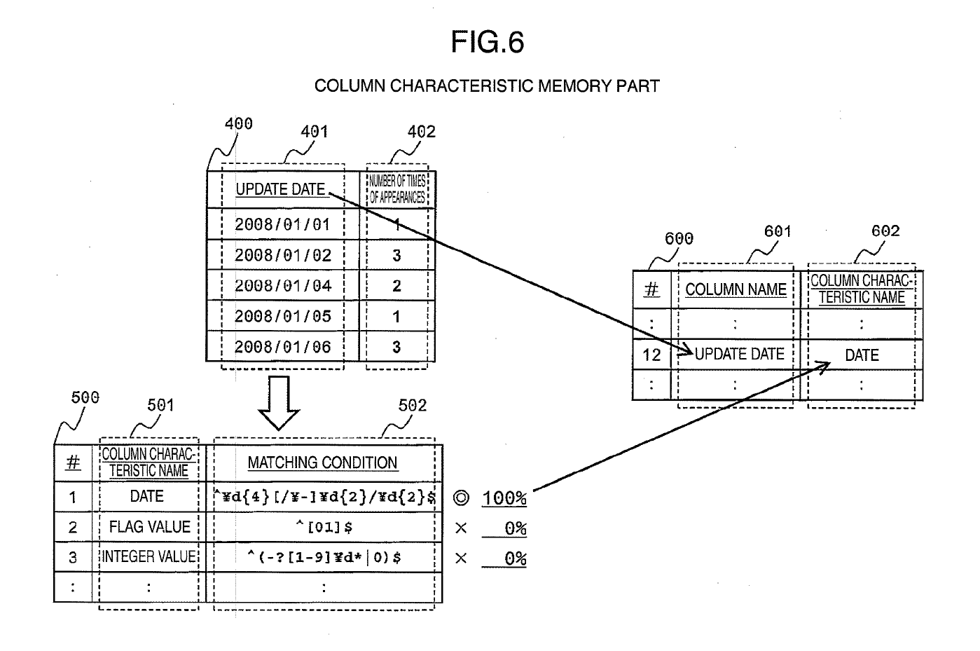

FIG. 6 shows an example of an image diagram explaining the processing for preparing the column characteristic information in the embodiment. The column characteristic information 600 has column names 601 and column characteristic names 602. The column characteristic judgment part 114 records the column names corresponding to the information 400 indicating the number of times of appearances of column values as the column names 601. Further, the column characteristic judgment part 114 calculates the rate of data satisfying the matching conditions 502 for column characteristics of columns for the purpose of judgment of the column characteristic names 602. In the embodiment, when the column values 401 of “update date” have the column characteristic name “date”, data are matched to be equal to 100%. Since the matching rate exceeds a threshold 80%, it is judged that the column characteristic of the “update date” is “date” and the column characteristic name 501 of the judgment result is recorded as the column characteristic name 602 of the column characteristic information 600. Further, the rate may be calculated by the actual number of appearances or genus of appearances.

Further, when the rate is larger than or equal to a fixed value in plural column characteristics, one column characteristic may be decided by selecting the column characteristic having the maximum rate or the like. Alternatively, each of the column characteristics may be adopted as providing plural column characteristics in one column. In the embodiment, the following steps are described as providing one column characteristic in one column, for simplification.

In step 205, the correlation rule extraction processing part 116 counts appearances of sets of values in respective columns while referring to data of columns read out from the memory part 106 for storing table data to be analyzed and writes the result thereof into the correlation rule memory part 110.

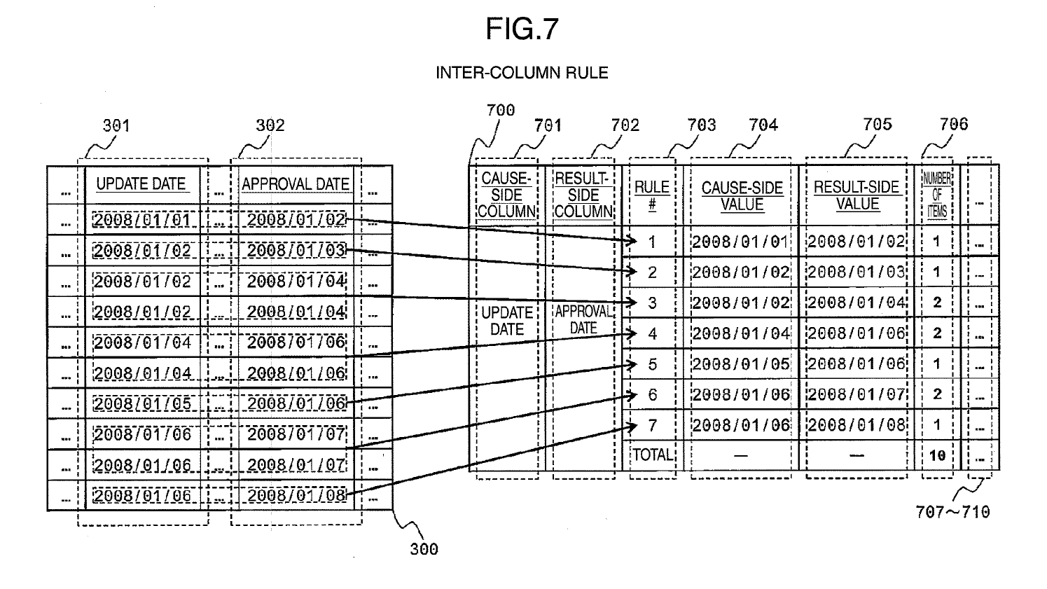

FIG. 7 shows an example of an image diagram explaining the processing for counting appearances of sets of column values in the embodiment. Inter-column correlation rule information 700 preserves cause-side column name 701, result-side column name 702, cause-side value 704, result-side value 705, number of items 706, summarization rule 707, number of items 708 on the cause side, number of items on the result side 709 and Lift value 710. Among them, in step 205, information of the cause-side column name 701, the result-side column name 702, the cause-side value 704, the result-side value 705 and the number of items 706 are registered.

The correlation rule extraction processing part 116 registers column names of the “cause-side column” and the “result-side column” selected in step 202 as the cause-side column name 701 and the result-side column name 702, respectively. Furthermore, the correlation rule extraction processing part 116 preserves the “update date” 301 and the “approval date” 302 which are the cause-side column and the result-side column of the input information 300, respectively, as the set of values of the cause-side value 704 and the result-side value 705 after eliminating duplication in combination thereof. Moreover, the correlation rule extraction processing part 116 counts appearances of the sets of values by referring to values of the “update date” 301 and the “approval date” 302 and registers the counted result as information of the number of items 706.

In step 206, the correlation rule summarization rule judgment part 115 selects the correlation rule summarization rules using the correlation rule summarization rules read out from the correlation rule summarization rule memory part 109 while referring to the column characteristic information read out from the column characteristic memory part 108 and writes the selected rules in the correlation rule memory part 110 as information of the correlation rules held therein.

Moreover, the correlation rule summarization rule judgment part 115 derives the correlation rule summarization names for extracted correlation rules using the selected correlation rule summarization rules and writes the derived names in the correlation rule memory part 110 as information of the correlation rules held therein.

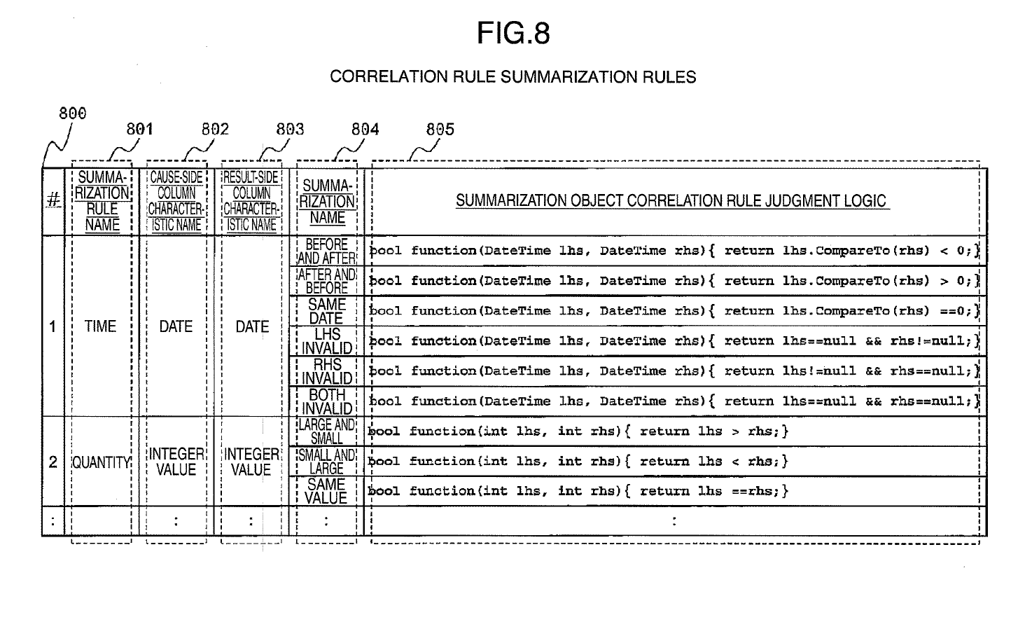

FIG. 8 shows an example of an image diagram explaining the correlation rule summarization rules in the embodiment. The correlation rule summarization rules 800 have summarization rule names 801 and cause-side column characteristic names 802 and result-side column characteristic names 803 corresponding to the summarization rule names. Further, each of summarization rule names 801 has plural summarization names 804 and summarization object correlation rule judgment logics 805. Any information described in the summarization object correlation rule judgment logics 805 is the functional information which has two input values and returns truth or falsehood value.

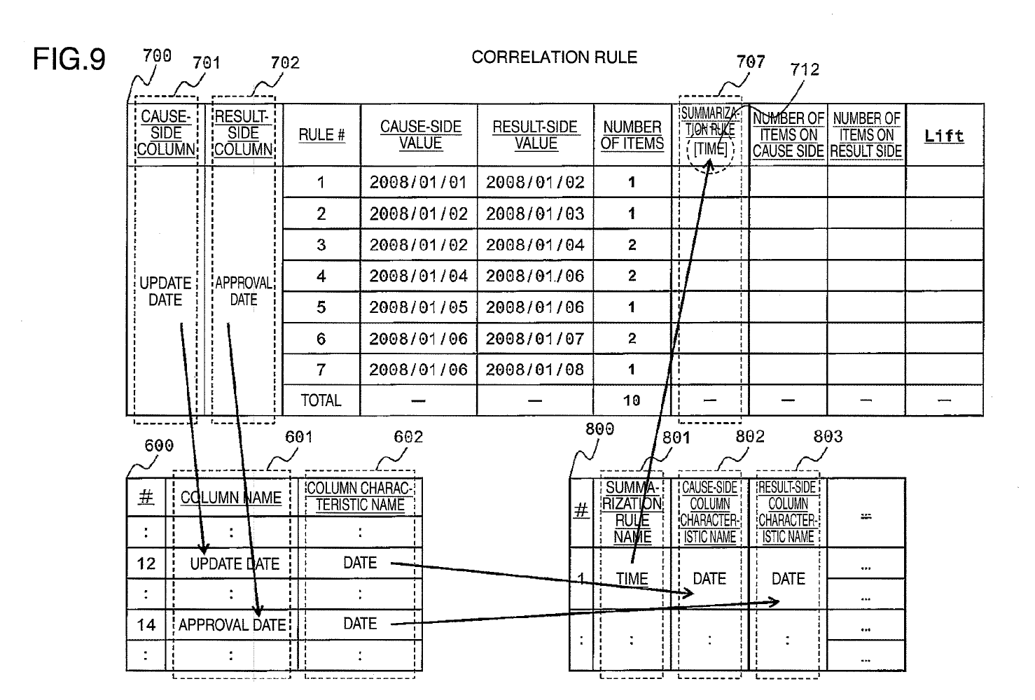

FIG. 9 shows an example of an image diagram explaining the processing for selecting the correlation rule summarization rules in the embodiment. The correlation rule summarization rule judgment part 115 extracts information corresponding to the cause-side column names 701 and the result-side column names 702 held in the inter-column correlation rule information 700 by finding out the same column names from the column names 601 of the column characteristic information 600. Further, the correlation rule summarization rule judgment part 115 extracts the column characteristic names 602 corresponding to the column names 601. Thereafter, the summarization rules having the extracted column characteristic names as the cause-side column characteristic names 802 and the result-side column characteristic names 803 are found out from the correlation rule summarization rules 800. In FIG. 9, in order to show the found-out results explicitly, the summarization rule names 801 are described as additional information 712 of the summarization rules 707 of the inter-column correlation rule information 700.

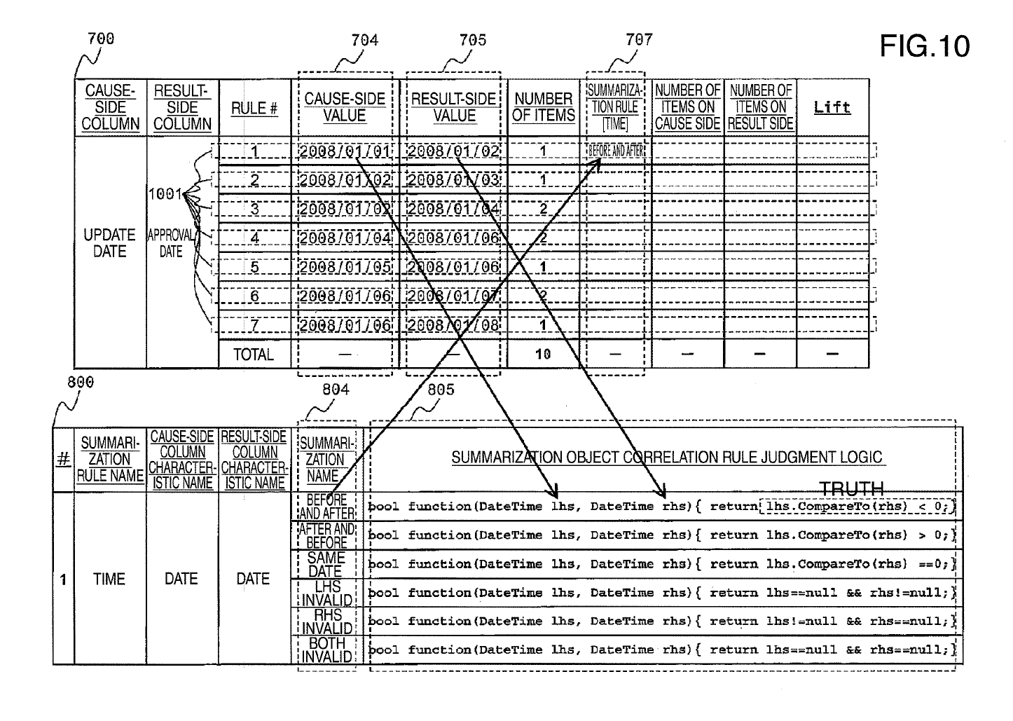

FIG. 10 shows an example of an image diagram explaining the processing for deriving the correlation rule summarization names in the embodiment.

The correlation rule summarization rule judgment part 115 selects one of the correlation rules held in the inter-column correlation rule information 700. Thereafter, the functions of the summarization object correlation rule judgment logics 805 found out as above are successively executed using the cause-side values 704 and the result-side values 704 of the selected correlation rules as input parameters. When the result of truth is obtained by the execution, the summarization name 804 is registered as the summarization rule 707 of the correlation rule being selected. When the result of falsehood is obtained by the execution, this processing is repeated until truth is obtained. When the result of all functions is false, the summarization rule 706 may be left to be blank. The same processing is performed for each of correlation rules 1001 held in the inter-column correction rule information 700, so that operation in step 206 is completed.

In step 207, the correlation rule pre-summarization processing part 117 rearranges the correlation rules read out from the correlation rule memory part 110 and updates the information in the correlation rule memory part 110. Furthermore, the correlation rule pre-summarization processing part 117 reads out the correlation rules from the correlation rule memory part 110 and calculates necessary numerical values while referring to the number of times of appearances of column values read out from the memory part 121 for storing the number of times of appearances of column values and the correlation rule summarization rules read out from the correlation rule summarization rule memory part 109, so that the information is complemented. Thereafter, the correlation rule pre-summarization processing part 117 writes the information in the correlation rule memory part 110 as the correlation rule thereof again.

Then, the correlation rule pre-summarization processing part 117 calculates an index value of the correlation rule using the information of the correlation rule read out from the correlation rule memory part 110 and updates the information of the correlation rule. Thereafter, the information is written as the correlation rule of the correlation rule memory part 110 again.

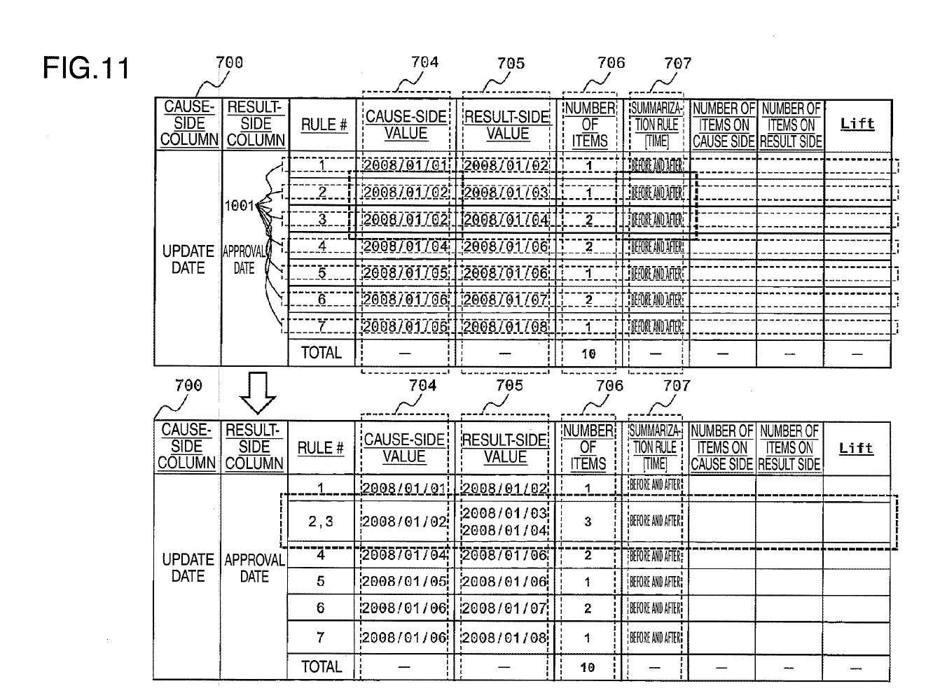

FIG. 11 shows an example of an image diagram explaining the processing for rearranging the correlation rules in the embodiment. The correlation rule pre-summarization processing part 117 extracts a combination of correlation rules having the same cause-side values 704 and the same correlation rules 707 from among the correlation rules 1001 held in the inter-column correlation rule information 700. The extracted correlation rules are integrated into one to thereby rearrange the correlation rules. In the rearrangement, the result-side values 705 are a list of result-side values held by the rules before rearrangement and the number of items 706 is a sum of the number of items held by the rules before rearrangement. Further, the cause-side values 704 and the summarization rules 707 may be values held in the rules before rearrangement. Such processing is performed until the correlation rules having the same cause-side values 704 and the same summarization rules 707 are reduced to zero, so that rearranged inter-column correlation rule information is prepared.

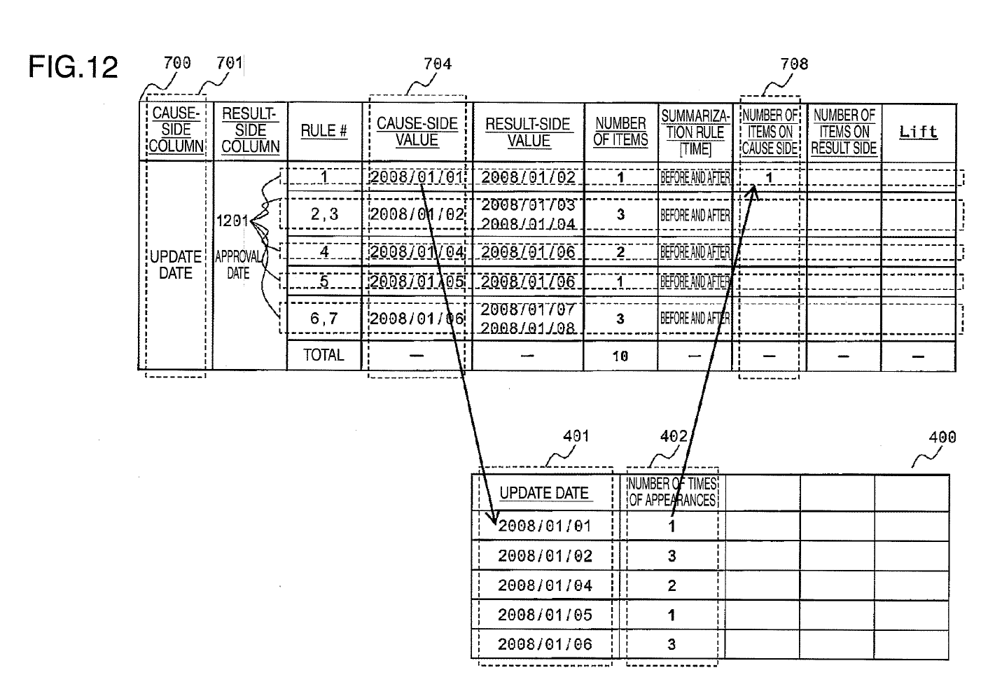

FIG. 12 shows an example of an image diagram explaining the processing for complementing information indicating the number of items on the cause side of the correlation rules rearranged in the embodiment. The correlation rule pre-summarization processing part 117 reads out the information 400 indicating the number of times of appearances of column values corresponding to the cause-side column name 701 held in the inter-column correlation rule information 700 from the memory part 121 for storing the number of times of appearances of the column values. Thereafter, information corresponding to the cause-side values 704 is found out from the column values 401 of the information 400 indicating the number of times of appearances of column values read out as above in regard to each of the rearranged correlation rules 1201 held in the correlation rule information 700 and the number of times 402 of appearances corresponding to the found-out results is recorded as the number of items 708 on the cause side of the correlation rules 1201. Such processing is performed for the correlation rules 1201 held in the inter-column correlation rule information 700 to thereby complement the information of the number of items 708 on the cause side.

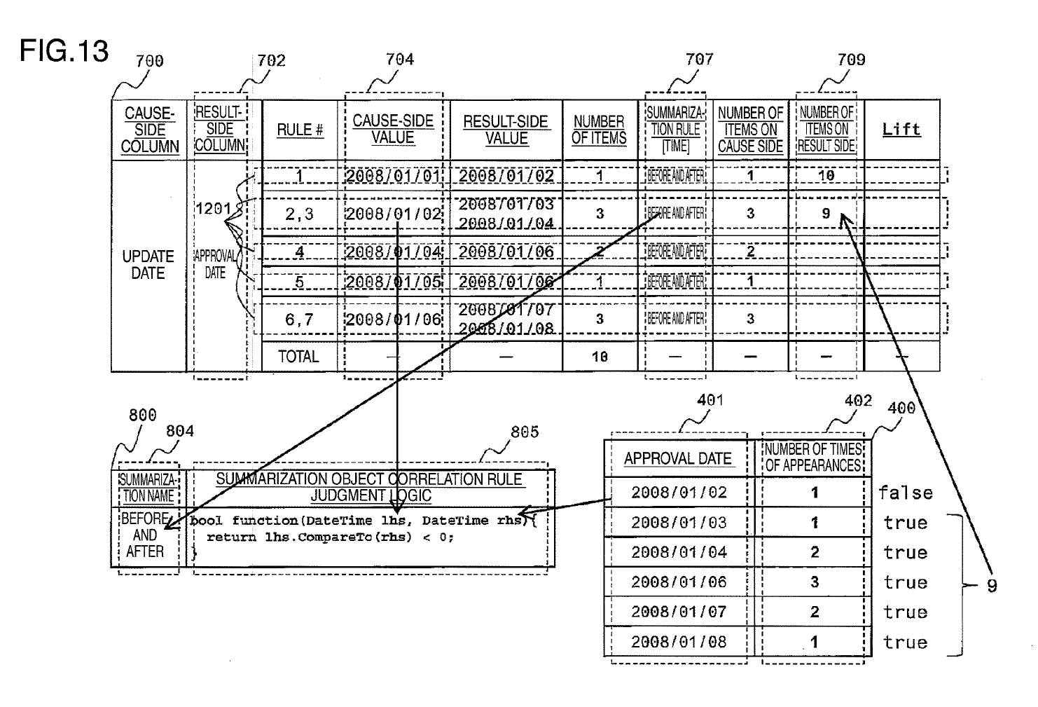

FIG. 13 shows an example of an image diagram explaining the processing for complementing the information indicating the number of items on the result side of the rearranged correlation rules in the embodiment. The correlation rule pre-summarization processing part 117 reads out the information 400 indicating the number of times of appearances of column values corresponding to the result-side column names 702 held in the inter-column correlation rule information 700 from the memory part 121 for storing the number of times of appearances of column values. Thereafter, the correlation rule pre-summarization processing part 117 selects one of the rearranged correlation rules 1201 held in the inter-column correlation rule information 700 and extracts the summarization object correlation rule judgment logic 805 corresponding to the summarization rule 707 for the selected correlation rule by finding out the summarization rule having the same summarization name 804 from among the correlation rule summarization rules 800 read out from the correlation rule summarization rule memory part 109. Moreover, the correlation rule pre-summarization processing part 117 executes the extracted summarization object correlation rule judgment logic 805 using the cause-side value 704 of rearranged correlation rule being selected as a first input parameter and the column value of the read-out information 400 indicating the number of times of appearances of column values as a second argument. The correlation rule pre-summarization processing part 117 writes the sum of the number of times 402 of appearances corresponding to the column values having the execution result that is truth as the number of items 709 on the result side of the rearranged correlation rules being selected. Such operation is performed for the rearranged correlation rules 1201 held in the inter-column correlation rule information 700, so that information of the number of items 709 on the result side is complemented.

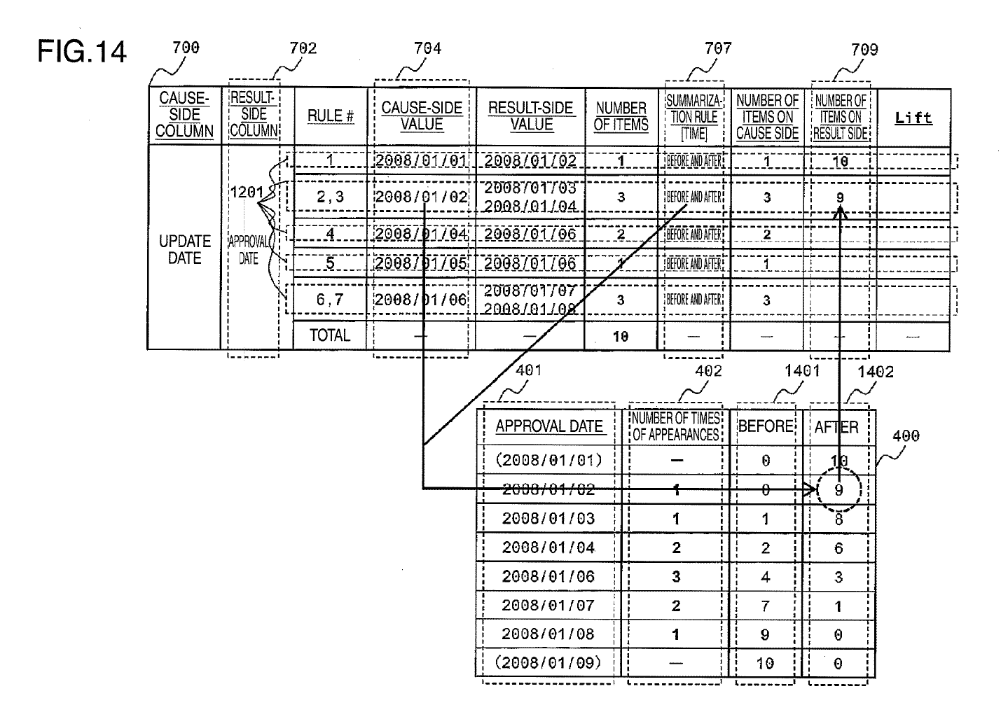

FIG. 14 shows an example of an image diagram explaining the number of times of appearances of column values used to efficiently perform the processing for complementing the information of the correlation rules in the embodiment. Since execution of the processing described in FIG. 13 can be omitted each time the summarization object correlation rule judgment logic 805 is executed by counting the values falling within each range on the basis of the partial order relation like the number of times 400 of appearances of column values described in FIG. 14, the processing can be performed efficiently. Concretely, first, the number of appearances 1401 of dates before the column value 401 and the number of appearances 1402 of dates after the column value 401 in the information 400 indicating the number of times of appearances of column values corresponding to the result-side column 702 of the inter-column correlation rule information 700 are calculated by calculation of the sum of values within the relevant range of the number of times of appearances 402. The correlation rule pre-summarization processing part 117 discovers information of the number of items 709 on the result side for the rearranged correlation rules 1201 to be complemented by finding out pertinent parts from the number of times 400 of appearances of column values while referring to the correspondence relation of the cause-side values 704 and the column values 401 and the contents of the summarization rules 707.

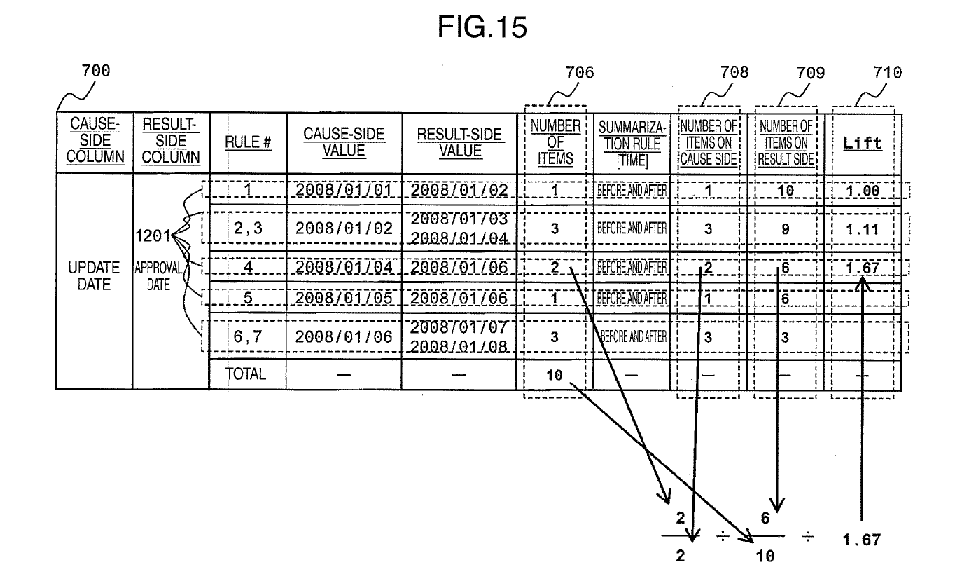

FIG. 15 shows an example of an image diagram explaining the processing for calculating index values from information of the correlation rules to be updated in the embodiment. The correlation rule pre-summarization processing part 117 calculates the following value about the rearranged correlation rules 1201 held in the inter-column correlation rule information 700 to thereby calculate Lift values of the respective correlation rules.

(number of items of relevant correlation rules/number of items on cause side)/(number of items on result side/total of number of items of correlation rules)

The calculated value is written in the inter-column correlation rule information 700 as Lift value 710 of the correlation rules. Information in the correlation rule memory part 110 is updated by the written inter-column correlation rule information 700 to thereby complete the step.

Furthermore, here, only the Lift value is calculated as the index value of the correlation rules, although Support value, Confidence value and the like which are other index values may be calculated together in this processing. In step 208, the correlation rule summarization processing part 118 summarizes or puts the information of correction rules read out from the correlation rule memory part 110 together on the basis of the community of summarization names of the correlation rules and then writes the information in the correlation rule summarization result memory part 111 as the summarized correlation rules.

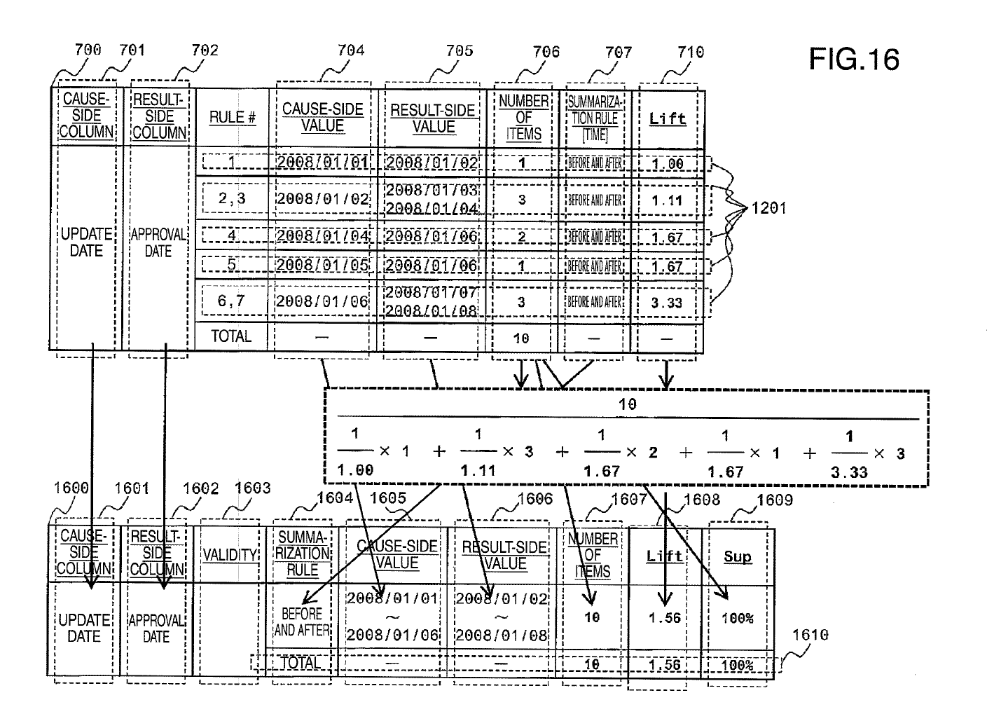

FIG. 16 shows an example of an image diagram explaining the processing for summarizing the correlation rules in the embodiment. The correlation rule summarization processing part 118 prepares summarized correlation rules 1600 for the inter-column correlation rule information 700 read out from the correlation rule memory part 110. The summarized correlation rules 1600 include cause-side column name 1601, result-side column name 1602, validity 1603, summarization rule 1604, cause-side value 1605, result-side value 1606, number of items 1607, Lift value 1608 and Support value 1609. The correlation rule summarization processing part 118 registers the cause-side column names 701 of the read-out inter-column correlation rule information 700 as the cause-side column names 1601 of the summarized correlation rules 1600 and the result-side column name 702 as the result-side column names 1602 of the summarized correlation rules 1600. Thereafter, the correlation rule summarization processing part 118 divides the rearranged correlation rules 1201 held in the inter-column correlation rule information 700 into groups each having the same summarization rule 707. Furthermore, the correlation rule summarization processing part 118 adds information of summarization rule 1604, cause-side value 1605, result-side value 1606, number of items 1607, Lift value 1608 and Support value 1609 to the summarized correlation rules 1600 for each of groups divided as above. Values of summarization rules 707 common to the correlation rules 1201 of the pertinent group are described as information of the summarization rules 1604. Upper limit values and lower limit values in partial order relation of the cause-side values 704 appearing in the correlation rules 1201 of the pertinent group are described as information of the cause-side values 1605. Upper limit values and lower limit values in partial order relation of the result-side values 705 appearing in the correlation rules 1201 of the pertinent group are described in information of the result-side values 1606. The total of the number of items 706 of the correlation rules 1201 of the pertinent group is described in the number of items 1607. Harmonic means of the Lift values 710 of the correlation rules 1201 of the pertinent group are described in the Lift values 1608. Values obtained by dividing the total of the number of items 706 of the correlation rules 1201 of the pertinent group by the total of the number items 706 of all correlation rules 1201 to be summarized are described in the Support values 1609.

Further, after computation of the number of items 1607, the Lift values 1608 and the Support values 1609 for all groups divided as above is completed, the number of items 1607, the Lift values 1608 and the Support values 1609 as totalized evaluation values 1610 of the summarized correlation rules 1600 may be calculated. In this case, the total value of the number of items 1607 of all groups to be summarized is calculated to be described in the number of items 1607. The harmonic mean of the Lift values 1608 of all groups to be summarized is calculated to be described in the Lift values 1608. The total value of the Support values 1609 of all groups to be summarized is calculated to be described in the Support value 1609.

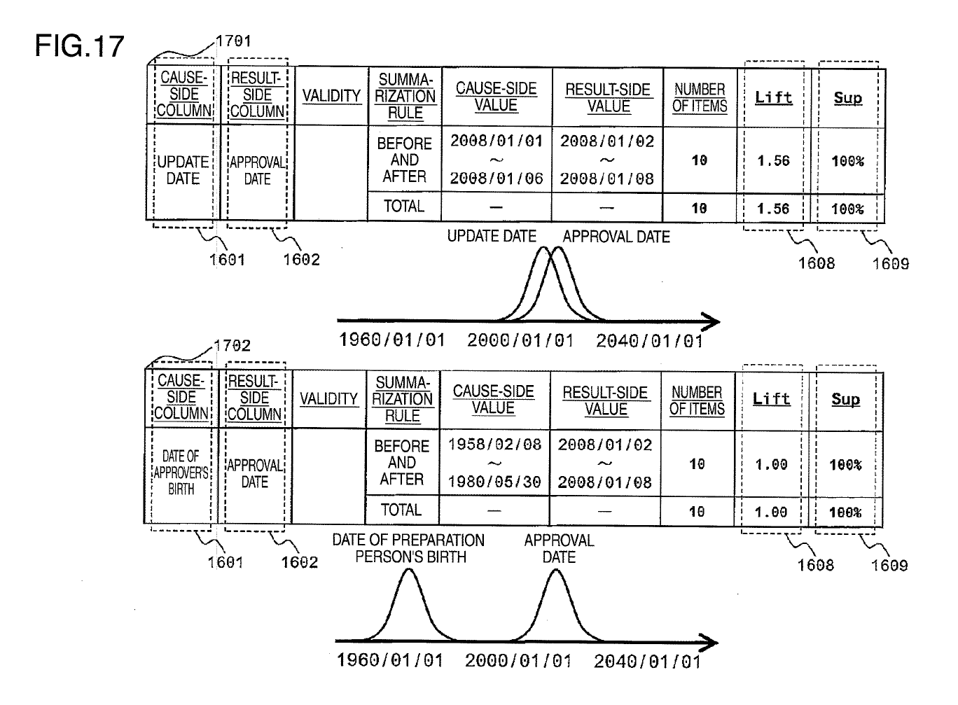

FIG. 17 shows an example of an image diagram explaining difference depending on the Lift values of the correlation rule summarization results in the embodiment. Summarized correction rule 1701 is the summarized correlation rule described as the examples in the embodiment and is derived using the “update date” 301 and the “approval date” 302 in the input information 300 of FIG. 3 as the cause-side column 1601 and the result-side column 1602, respectively. Further, summarized correlation rule 1702 is derived using the “date of approver's birth” 304 and the “approval date” 302 as the cause-side column 1601 and the result-side column 1602, respectively, by means of the same method as that for deriving the above summarized correlation rule 1701.

The Support values 1609 of all the summarized correlation rules are 100% and since the relation of before and after in time always comes into effect, the summarized correlation rules are considered to be effective rules as the specifications when judgment is made from only the viewpoint of the Support values. However, the Lift value 1608 in the correlation rules 1702 is as low as 1.0 and it is shown that usefulness as the specification is low.

Further, the Lift value is a value representing the degree that the range taken by the “result-side value” is narrowed by the “cause-side value” and is a value expressed by the magnifying factor which is a reference value (1.0) when the “cause-side value” is not prescribed. When the value is 1.0, restriction conditions are not specifically added by the “cause-side value” and accordingly it can be judged that the usefulness as the correlation rules is low.

In case of the relation of before and after in the example of FIG. 17, the Lift value 1608 calculated in the method is 1.0 when there is no overlap in the data distribution area between the cause-side column 1601 and the result-side column 1602. By referring to the Lift value, it can be discovered that there is no overlap in the data area originally and it is difficult to consider that the value of the “result-side column” 1602 is influenced by a specific appearance value of the “cause-side column” 1601 in the specifications.

In step 209, the summarization result appropriateness judgment part 119 refers to information of the summarized correlation rules read out from the correlation rule summarization result memory part 111 and complements the correlation rule using information of the summarized correlation rule evaluation rules read out from the summarized correlation rule evaluation rule memory part 112. Thereafter, the complemented correlation rule is written in the summarized correlation rule memory part 111 again.

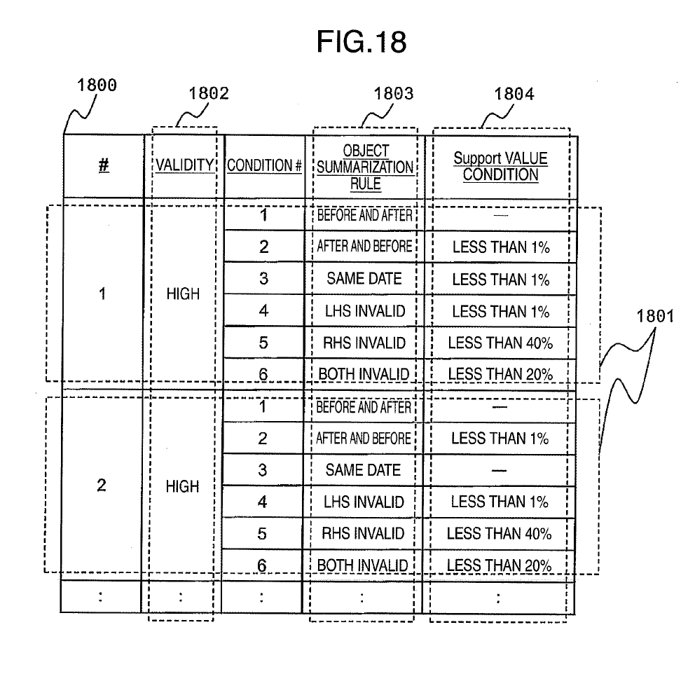

FIG. 18 shows an example of an image diagram explaining the rules for complementing the information of the correlation rule summarization result in the embodiment. Summarized correlation rule evaluation rules 1800 include one or more summarized correlation rule validity judgment conditions 1801 and each of the summarized correlation rule validity judgment conditions 1801 has validity information 1802. Further, the summarized correlation rule judgment conditions 1801 have one or more sets of object summarization rules 1803 and Support value conditions 1804. Values described in the object summarization rules 1803 are any of values used as the summarization names 804 described in the correlation rule summarization rules 800. Moreover, the contents described in the Support value conditions 1804 show restriction conditions for numerical value.

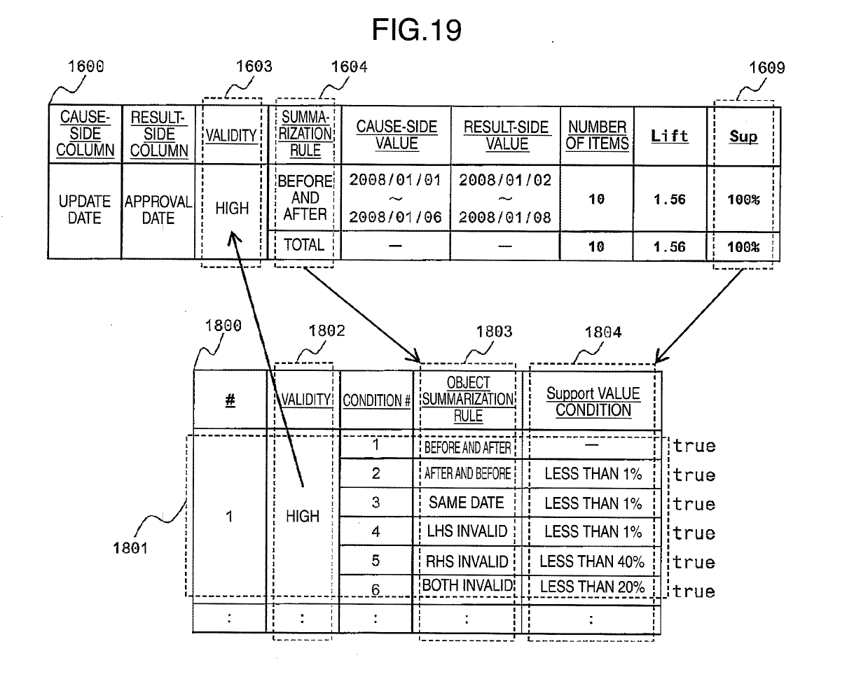

FIG. 19 shows an example of an image diagram explaining the processing for complementing the information of the correlation rule summarization results in the embodiment. The summarization result appropriateness judgment part 119 extracts the summarized correlation rule judgment conditions 1801 corresponding to the summarized correlation rules 1600 read out from the correlation rule summarization result memory part 111. Concretely, the summarized correlation rule judgment conditions 1801 are judged from the top of the summarized correlation rule evaluation rules 1800 and the summarized correlation rule judgment condition 1801 coincident with the conditions first is extracted.

When the summarized correlation rule judgment conditions 1801 are extracted, all sets of the object summarization rules 1803 and the Support value conditions 1804 held by the summarized correlation rule judgment conditions are subjected to judgment about the conditions described later. When the conditions are satisfied for all cases, it is judged that agreement is obtained for all conditions and the summarized correlation rule judgment conditions 1801 are extracted.

In judgment of the conditions represented by the sets of object summarization rules 1803 and Support value conditions 1804, the summarization rules 1604 having the same value as the object summarization rules 1803 are first found out from the summarized correlation rules 1600 to extract the Support values 1609 corresponding to the found-out rules. When the summarization rules 1604 having the same value as the object summarization rules 1803 are not found out, it is regarded that the Support value is 0%. Thereafter, it is judged whether the extracted Support value satisfies the restriction conditions of the Support value conditions 1804.

Moreover, when the summarized correlation rule judgment conditions 1801 corresponding to the summarized correlation rules 1600 cannot be extracted from the summarized correlation rule evaluation rules 1800, the processing in step 209 may be ended while the validity 1603 of the summarized correlation rules 1600 is left blank. The blank state represents that the contents of the summarized correlation rules 1600 are not the rule structure supposed as the specifications and the contents are information having the low useful degree as the specifications.

In step 210, the user of the Invention obtains the analysis results of data by the correlation rule analysis apparatus 100 through the output unit 104. The summarization result visualization processing part 120 reads out the correlation rule summarization results from the correlation rule summarization result memory part 111 in accordance with the instruction of the user of the apparatus and converts the results into a visually and easily understandable format to be then outputted to the output unit 104. Further, the output may be produced as text data or binary data so that the data can be treated by a computer or may be displayed in a monitor in character or graphically so that a developer can read the output.

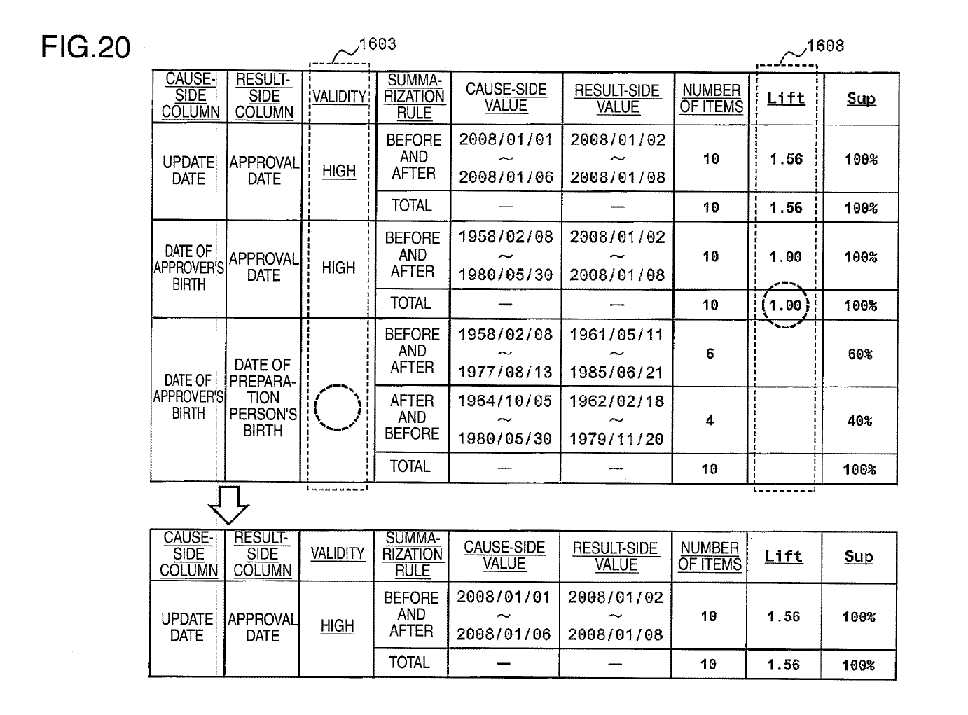

FIG. 20 shows an example of an image diagram explaining the processing for converting the correction rule summarization results into a visually and easily understandable format in the embodiment. The correlation rule visualization processing part 120 reads out the summarized correlation rules from the correlation rule summarization result memory part 111. Furthermore, the summarized correlation rules designated by the user of the apparatus and having the high useful degree (here, the usefulness 1603 is “high” and the Lift value 1608 is “1.05 or more”) from among the read-out summarized correlation rules are specified to be extracted and then are outputted to the output unit 104.

It should be further understood by those skilled in the art that although the foregoing description has been made on embodiments of the invention, the invention is not limited thereto and various changes and modifications may be made without departing from the spirit of the invention and the scope of the appended claims.

1. A correlation rule analysis apparatus which extracts at least one of data dependence relation and restriction conditions of columns of a database from data stored in the database, comprising:
correlation rule extraction means to extract information of simultaneous appearance relation of data among plural columns as correlation rules from data of a database table in which data to be analyzed are stored;
correlation rule summarization means to summarize the extracted correlation rules on the basis of specific community; and
summarization result appropriateness judgment means to calculate usefulness indexes as the data dependence relation and the restriction conditions from appearance frequency and combination in the summarized correlation rules.

2. A correlation rule analysis apparatus according to claim 1, wherein
the specific community includes identity of partial order relation coming into effect between values of condition parts and conclusion parts of the correlation rules.

3. A correlation rule analysis apparatus according to claim 2, further comprising:
column characteristic judgment processing means to judge features of the data of the database from the data; and
correlation rule summarization rule judgment means to decide framework of the community applied to summarize the correlation rules from the features of the data of the database.

4. A correlation rule analysis apparatus according to claim 2, further comprising:
correlation rule pre-summarization processing means to calculate Lift values of the correlation rules before summarization in consideration of contents of the partial order relation when the correlation rules are summarized on basis of the identity of the partial order relation.

5. A correlation mile analysis apparatus according to claim 4, wherein
the correlation rule pre-summarization processing means makes calculation of the Lift values by utilizing as temporary data a sorted table in which the number of times of appearances counted of the values in the conclusion parts is set when the Lift values are calculated.

6. A correlation rule analysis apparatus according to claim 1, wherein
the correlation rule summarization processing means calculates the Lift values of the summarized correlation rules as harmonic averages of the Lift values of the correlation rules before summarization.

7. A correlation rule analysis apparatus according to claim 2, wherein
the partial order relation contains before-and-after relation of values as date.

8. A correlation rule analysis apparatus according to claim 2, wherein
the partial order relation contains magnitude relation of numerical values.

9. A correlation rule analysis apparatus according to claim 1, further comprising:
summarization result visualization processing means to decide order and range by index values of usefulness judged by the summarization result appropriateness judgment means when the summarized correlation rules are outputted.
